(19) United States
(12) Patent Application Publication
(10) Pub. No.: US 2006/0167638 A1
(43) Pub. Date: Jul. 27, 2006

(54) Data collector with wireless server connection

(76) Inventors: Jonathan David Miller Murphy, Oceanside, CA (US); Johannes Izak Boerhout, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/982,271

(22) Filed: Nov. 4, 2004

(51) Int. Cl. G01L 7/00; G01F 17/00

(52) U.S. Cl. 702/56

(57) ABSTRACT

Data is transmitted from a portable handheld device (“HHD”) at a remote site to a control facility using wireless data transmission. In response, the control facility creates and sends a measurement instruction or command to the HHD. The command sent to the HHD can be based at least in part on the data previously received from the HHD.

### BACKGROUND OF THE INVENTION

1. Field of the Invention

The present invention relates to real-time monitoring and analysis of operational characteristics for a machine.

2. Description of the Related Technology

The need to accurately predict excessive wear, functional abnormalities, or the imminent malfunction of machines such as pumps, turbines, and the like is well known. It has become common to use vibration transducers which convert an operating machine's mechanical vibrations into an electrical signal which can be analyzed for characteristics which indicate abnormal operation or the need for maintenance. It can be appreciated that resources can be more efficiently utilized in manufacturing facilities and other environments when machine failure can be predicted, and the machine fixed or replaced prior to catastrophic failure. Human safety is also improved if the incidence of significant machine malfunction is reduced or eliminated.

In some installations, a portable handheld device (“HHD”) is carried around the facility by facility personnel, and is used to collect vibration and temperature data from various locations on the machinery being monitored. The operator downloads a set of instructions in the form of a route to the HHD from a central server. The route can specify, for example, the type of measurement to be taken as well as the order in which to take the measurements. While conducting the route, the HHD prompts the user with the appropriate instructions and logs the data to its internal memory. After the route is completed, the operator uploads the logged data to the central server. Analysis of the uploaded data can identify operating characteristics or trends of the machine.

In the above-described system, however, the central server and HHD upload and download the route and logged data in volume. With such an arrangement, contiguous blocks of time are required to download the route or to upload the data. If analysis of the data taken during a first visit to the machine indicates that additional data would be beneficial in analyzing the operational characteristics or trends of the machine, a second visit to the machine may be required. Further, as the complexity of routes increases, the memory required to store the route within the HHD increases. As more memory is allocated to the route, less memory is available for data.

### SUMMARY OF THE INVENTION

The systems and methods of the present invention have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of the Preferred Embodiments” one will understand how the features of this invention provide several advantages over traditional machine monitoring systems.

One aspect of the present invention is a wireless monitoring system for measuring and processing operational characteristics of one or more machines. The system comprises a central computer configured to determine a first series of measurement instructions for the one or more machines and a portable computer configured to receive each instruction from the first series of measurement instructions over a wireless link and to serially transmit measurement data over the wireless link, wherein at least a portion of the instructions for the first series of measurement instructions is transmitted after a portion of the first series of measurement instructions have been completed.

Another aspect of the present invention is a wireless monitoring system that comprises a central computer configured to determine a first series of measurement instructions and to select a first measurement instruction from the first series of measurement instructions, a transmitter configured to transmit the first measurement instruction over a wireless link, and a portable computer configured to receive the first measurement instruction and to transmit measurement data taken in response to the first measurement instruction over the wireless link.

Still another aspect of the present invention is a method of monitoring the condition of a machine. The method comprises selecting a first measurement instruction at a central computer, wirelessly receiving the first measurement instruction, connecting a transducer to the machine for collecting data, wherein the data relates to the first measurement instruction and transmitting the data to the central computer. The method further comprises processing the transmitted data at the central computer, selecting a second measurement instruction at the central computer, and wirelessly receiving the second measurement instruction from the central computer.

Yet another aspect of the present invention is a portable computer for an operator to receive and display instructions for measuring operational characteristics of a machine. The portable computer comprises means for wirelessly receiving an instruction from a central computer to measure an operational characteristic of the machine, software configured to interpret the received instruction, and a processor configured to execute the software. The portable computer further comprises a graphical user interface configured to display information related to the instruction and to the operational characteristic of the machine, a connector configured to receive data related to the operational characteristic, and means for transmitting the data to the central computer.

An additional aspect of the present invention is a central computer for determining a plurality of instructions for an operator to perform a plurality of measurements to determine the operational characteristics of a type of machine. The central computer comprises software configured to determine a series of instructions for the operator to perform the plurality of measurements, a processor configured to execute the software, and a transmitter configured to transmit a first instruction and a second instruction from the series of instructions to a portable computer over a wireless link. The central computer further comprises a receiver configured to receive data related to the transmitted first instruction from the portable computer over the wireless link and means for selecting the second instruction of the series of instructions based at least in part on the data related to the first instruction.

Still an additional aspect of the present invention is a method of monitoring the condition of a machine that comprises forming a wireless link between a central computer and a portable computer, wirelessly receiving a first measurement instruction from the central computer over the link, and connecting a transducer to the machine for collecting data relating to the first measurement instruction. The method further comprises transmitting the data to the central computer over the link and wirelessly receiving a second measurement instruction from the central computer over the link.

Yet another aspect of the present invention is a method of performing a machine monitoring data collection route comprising receiving data collection instructions from a central computer substantially continuously while performing the data collection route.

An additional aspect of the present invention is a method of simultaneously monitoring the condition of a plurality of machines at a central server. The method comprises forming a first wireless link between a central computer and a first portable device, wirelessly receiving a first measurement instruction from the central computer at the first portable device over the first wireless link, forming a second wireless link between the central computer and a second portable device, the second portable device being remotely located from the first portable device, and wirelessly receiving a second measurement instruction from the central computer at the second portable device over the second wireless link. The method further comprises transmitting collected data to the central computer over the second wireless link and wirelessly receiving a third measurement instruction at the first portable device over the first wireless link, wherein the third measurement instruction is determined using the data collected from the second portable device.

### BRIEF DESCRIPTION OF THE DRAWINGS

FIG. 1 is an illustration of a communication system wirelessly connecting a stationary machine being monitored and a central server in accordance with one embodiment of the present invention.

FIG. 2 is an illustration of a communication system wirelessly connecting a plurality of stationary machines being monitored and a central server in accordance with another embodiment of the present invention.

FIG. 3 is a block diagram of the components of a portable handheld device in accordance with one embodiment of the present invention.

FIG. 4 is a flowchart illustrating a method of data communication which may be implemented by the central server in the systems illustrated in FIGS. 1 and 2.

FIG. 5 is a flowchart illustrating a method of data communication which may be implemented by the portable handheld device in the systems illustrated in FIGS. 1 and 2.

FIG. 6 is a flowchart illustrating a method of data communication which may be implemented by the central server in the system illustrated in FIG. 2.

### DETAILED DESCRIPTION OF THE PREFERRED EMBODIMENTS

Preferred embodiments of the present invention will now be described with reference to the accompanying Figures, wherein like numerals refer to like elements throughout. The terminology used in the description presented herein is intended to be interpreted in its broadest reasonable manner, even though it is being utilized in conjunction with a detailed description of certain specific preferred embodiments of the present invention. This is further emphasized below with respect to some particular terms used herein. Any terminology intended to be interpreted by the reader in any restricted manner will be overtly and specifically defined as such in this specification.

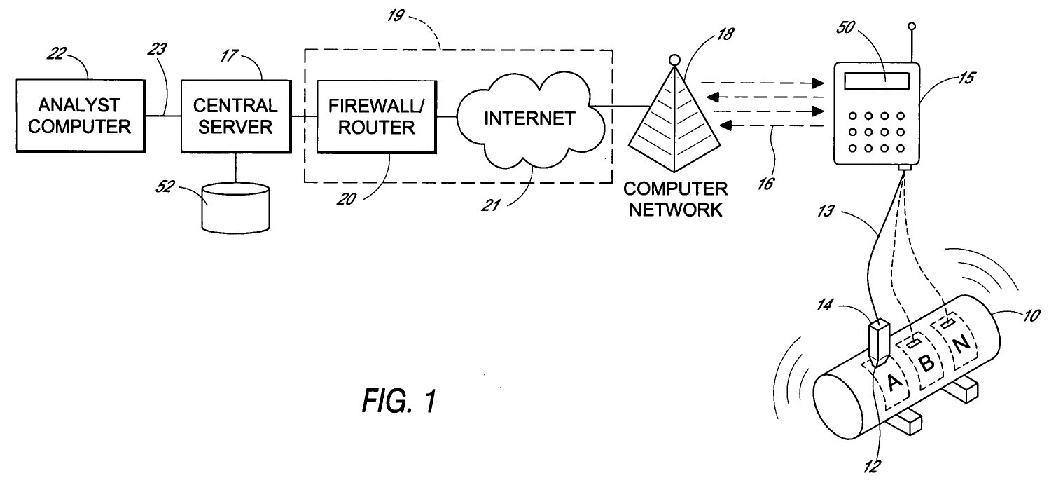

Referring now to FIG. 1, a communication system in accordance with a preferred embodiment of the present invention is illustrated. A piece of machinery 10, a high speed pump for example, incorporates pre-defined measuring points 12 at which vibration characteristics are to be measured. In some cases, each point is provided with a vibration transducer mounted to convert, for example, mechanical pump vibrations to an output analog electrical signal. Suitable transducers for this purpose are well known to those of skill in the art. Many standard configurations are described in the ANSI/API Standard 670, dated December 2000, the disclosure of which is hereby incorporated by reference in its entirety. More commonly, each measuring point 12 includes a stud or just a marking to which or on which a mechanical coupling provided as part of a portable handheld device (HHD) 14/15 is placed. Mechanical vibrations of the machine 10 are coupled to the device 14/15 and a transducer internal to the handheld device 14/15 converts the mechanical vibrations to an electrical signal. In many common embodiments, the portable HHD comes in two parts. A “pen” portion 14 that physically couples to the measuring point 12, and a hand-held processor portion 15 that includes additional user interfaces such as a complete keypad and large format display. The pen 14 and processor 15 may be connected by a cable 13 that is typically defined as a standard serial interface to provide automatic data transmission from the pen 14 to the hand-held processor 15. It is common to have the transducer and some processing circuitry present in the pen 14, and then further processing circuitry in the hand-held processor 15. In some cases, the pen 14 is not coupled by any cabling to the hand-held processor 15. In these cases, the pen may have a display that is read by the technician, who then inputs the displayed value into the hand-held processor 15. Any type of relevant data such as temperature, etc. may be gathered and input into the hand-held processor 15 in this manner.

In a two-way communication system applicable to the vibration monitoring system illustrated in FIG. 1, an outbound message containing vibration data may be sent by the HHD 15 which is at the machine being monitored to a computer network 18 via a wireless link 16. The network 18 may comprise a private network, a public cellular telephone network, may include a satellite and/or microwave link, or may be wholly terrestrial. This outbound message will be received by one or more wireless network devices. A device coupled directly to the wireless network may be the message destination, or the message may be forwarded to its destination either by land line, microwave repeater, or satellite link, for instance. The destination in FIG. 1 is a central server 17.

The HHD 15 can include a graphical user interface (“GUI”) 50 for displaying a series of instructions for the operator to follow when obtaining data from the machine 10. The instructions illustrated on the GUI 50 are received from the central server 17. The instructions can specify, for example, types of measurements and associated locations on the stationary machine 10 for obtaining the measurements. The stationary device illustrated in FIG. 1 includes locations A, B, through N. For example, the HHD 15 can instruct the operator to obtain a temperature measurement at location A followed by a vibration measurement at location B.

For ease of explanation, the term “route” is used as the term for a series of one or more measurement instructions sent to the HHD 15. As explained above, these measurement instructions specify measuring temperature, vibration, strain, or other characteristics of the stationary machine 10. In response to the measurement instruction, the operator locates an input device relative to the stationary machine 10 for obtaining the desired data at the specified measurement location. The HHD 15 uploads the data to the central server 17 via the wireless link 16. In a preferred embodiment of the present invention, the data measurements are uploaded before the entire route is completed. For example, if a route includes ten measurement instructions, before the tenth measurement is taken, one or more of the first nine measurements are uploaded to the central server 17 via the wireless link 16. In this way, the central server 17 can determine one or more of the subsequent measurement instructions at least in part based on the uploaded measurement(s).

This system design has many advantages. The time required to download routes to an HHD is reduced or eliminated, memory requirements are reduces, flexibility to change routes on the fly is provided. In addition, as will be explained further below, this system can be implemented with software that is in widespread use in Internet communication protocols, thus leveraging the cost benefits and interoperability provided by internationally adopted communication standards.

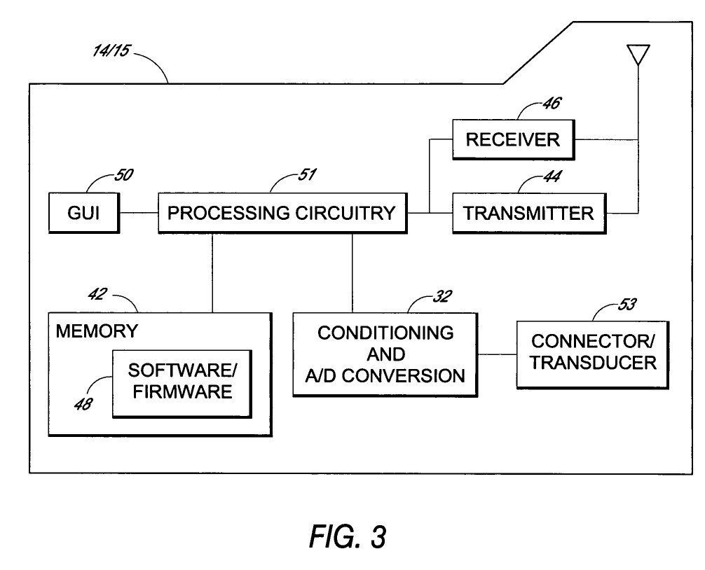

The HHD 15 includes circuitry which conditions and digitizes the analog transducer output signal as will be described in more detail below with reference to FIG. 3. The digitized data is then preferably transmitted to the central server 17 where it is stored in a memory 52 at the central server 17.

In some embodiments, the central server 17 is one of the computers of the network 18. In other embodiments, the data is forwarded to the central server 17 via a gateway 19. The gateway 19 can include a firewall/router 20 interfaced to a packet switched network such as the Internet 21. It will be appreciated by those of skill in the art that many communication protocols may be used with the present invention, including any of a number of switching techniques utilized and proposed for use in telecommunications networks, as well as techniques used in local or wide area computer networks. A Personal Communication Services (PCS) system may be deployed which combines many different types of voice and data communication services, including the transmission of commands or messages. These systems may utilize a high data rate full duplex communication hardware infrastructure for all transmissions. Alternatively, a paging network can be used as a simplex or half-duplex form of communication for short strings of data.

In many preferred embodiments of the present invention, the transmissions of the route to the HHD 15 and the data to the central server 17 can be handled by communications services that are commercially available to provide such wireless communication. This reduces the burden on facility management and allows them to concentrate on data analysis and facility maintenance, rather than on the operation and upkeep of a communications system.

The data received by the central server 17 can be transmitted to an analyst computer 22. In some embodiments of the present invention, the analyst computer 22 is located at the central server 17, and no additional communication link is required. In some other embodiments, however, a communication link 23 is preferably provided between the central server 17 and a control room containing the analyst computer 22. In some applications of the present communication system, the analyst computer 22 is located at a location remote from both the stationary monitored machine 10 and the central server 17. The communication link 23 may then advantageously comprise a public switched telephone network (PSTN). The link through the telephone network can be continuously connected to provide real-time transfer of vibration data to the analyst computer 22, or the link could be made periodically as the analyst computer desires to receive information. In the latter case, the memory 52 can be used to store the vibration data until it is downloaded to the analyst computer 22 via a telephone connection made between the analyst computer 22 and the central server 17.

The analyst computer 22 and central server 17 may be co-located at the same facility (and/or may be part of the computer network 18), in which case there is no need to use the telephone network. The communication link 23 may also comprise a private telecommunications network, and may further include additional wireless and wired links. As another alternative, the link 23 may comprise a packet switched network such as the Internet.

Many of the above described embodiments further enhance the advantageous characteristics of the present system in that almost the entire communication link from the machine 10 to the analyst computer 22 is supported by an existing communication infrastructure which is owned and managed by third parties rather than the managers of the machines and/or monitoring procedures.

The data taken at the measuring point 12 is analyzed, and appropriate action according to the results of the analysis may then be taken. The analysis may be performed at the central server 17 or the analyst computer 22. For example, the central server 17 can analyze the data received from the HHD 15 and determine the next measurement of the route based at least in part on the content of the data. This transmission of a measurement instruction back to the HHD 15 may occur after each data measurement is received at the central server 17 or after a series of data measurements are received. For example, the HHD 15 can send two data measurements and then receive a measurement instruction from the central server 17. In these embodiments, the instructions for the route can be sent in batches, or the whole route can be loaded to the HHD 15, and then selectively changed as desired by the server 17 as a monitoring technician performs the measurements and they are sent back to the server 17 over the wireless link 16.

Alternatively or in addition to sending a measurement instruction in response to the received data, the central server 17 schedules appropriate maintenance procedures when the measured data indicates that such maintenance is required. If required, a command for the operator to shut down the machine is sent to the HHD 15. In some cases, additional personnel may be dispatched to manually shut down the machine 10 being monitored.

For example, the central server 17 can wirelessly send a first measurement instruction to the HHD 15 instructing the operator to perform a specific measurement. The HHD 15 sends the data collected in response to the first measurement instruction back to the central server 17. The central server 17 then sends a second measurement instruction to the HHD 15. The second measurement instruction may be selected from a predetermined series of instructions or an instruction created or updated based at least in part on the data collected in response to the first instruction. For example, the central server 17 may send an instruction to take additional measurements at a specific location on the machine 10 based on the previously received data. Alternatively, the central server 17 could send an instruction to shut down the machine if the data measurements made by the transducer 12 indicate that bearing failure is imminent. The present system therefore incorporates a capacity for remote machine 10 control based at least in part on real-time data feedback, as well as increasing the efficiency of manual machine 10 control and maintenance.

As mentioned above, the network 18 is connected to the central server 17, where the data is evaluated and analyzed. An alternative or additional destination for the data sent from the HHD 15 may be a second HHD. This second HHD may be carried by a facility manager or technician that wishes to be kept informed of machine conditions when access to the central server 17 is limited. The HHD may in some embodiments also include transmission capabilities as well, so that a mobile facility manager or other user can send commands as well as receive them.

As is common in packet based networks; the data sent by the HHD 15 may be a short message. The data may therefore comprise an overall vibration measurement value, such as an enveloped acceleration measurement. The data sent from the HHD 15 may also be simply an alarm, indicating that a measurement has been taken which exceeds a programmed threshold. It will be appreciated that the data rates of typical packet systems may also allow continuous real time transmission of un-processed vibration data.

In many applications, the HHD will be battery powered. In these cases, it will be appreciated that reductions in energy consumption are desirable. It is advantageous in these instances to provide a battery management circuit which only powers those portions of the HHD necessary at any one time. Reductions in the number and length of messages will also enhance battery life.

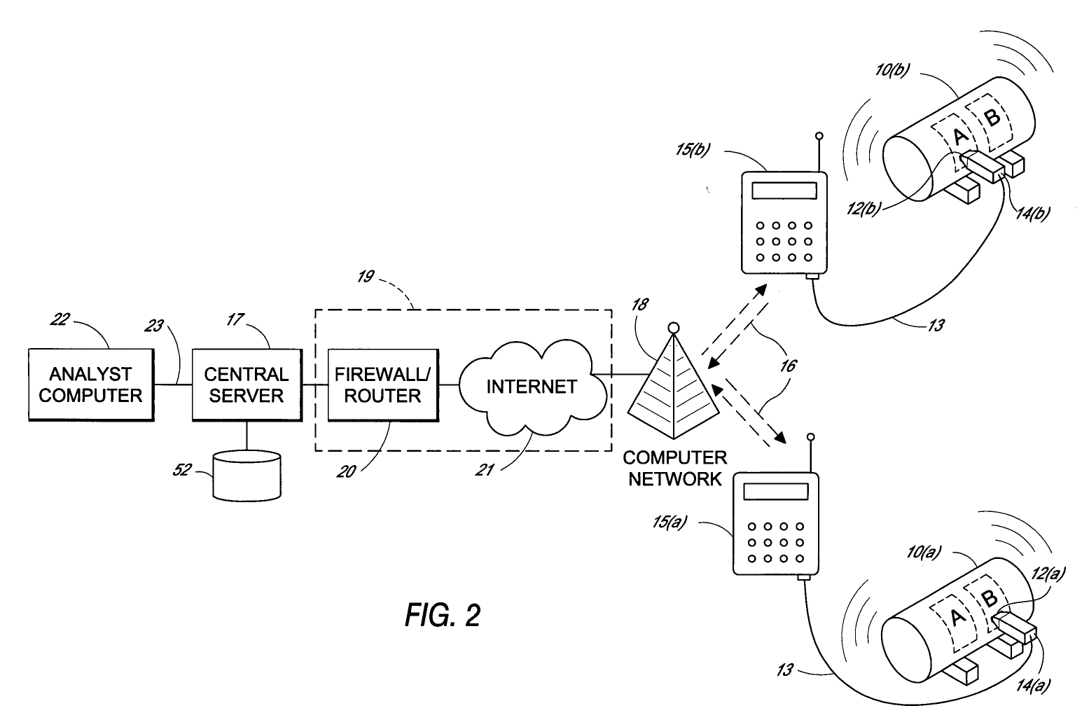

The embodiment illustrated in FIG. 2 is similar to that illustrated in FIG. 1. A second measuring point 12(b), however, is connected to a second HHD 15(b) which transmits wirelessly to the network 18. The data transmitted from the HHD 15(b) and to the network 18 can be further transmitted to the central server 17 or to the first HHD 15(a). Data transmitted to the central server 17 is processed as described earlier with respect to FIG. 1. However, the data received from either or both the HHD 15(a), 15(b) can be used to update the database 52 and/or to create measurement instructions for either or both HHD 15(a) and HHD 15(b). In this way, the database 52 relied upon by the central server 17 for creating an outgoing measurement instruction for HHD 15(a) is updated with data received from both HHD 15(a) and HHD 15(b). The data received by the central server 17 can be forwarded to the analyst computer 22 if necessary and in a manner similar to that described above with respect to FIG. 1. In effect, the HHD 15(b) (or the HHD 15(a)) can connect to the central server 17 or to the other HHD over wireless links 16. In this embodiment as well, therefore, communication between the machines 10(a), 10(b) and the central computer 17 is easily managed and maintained.

Components of the HHD 14/15 of FIG. 1 will now be described with reference to FIG. 3. A mechanical coupler and vibration transducer 53 pre provided so as to receive a mechanical acceleration signal from the machine 10, and translate that into an electrical signal. In typical applications, the transducer 53 comprises a piezoelectric crystal and an integral analog amplifier inside a housing. The transducer 53 will generally also be provided with an output for outputting a voltage which varies with the instantaneous acceleration of the point on the machine 10 that the transducer contacts. Of course, the physical nature of the vibration transducer can vary and remain within the scope of the present invention, and the term “vibration transducer” is not hereby limited to any particular construction. Many different transducer configurations and modes of coupling them to stationary rotating machinery are well known. Some are described in the ANSI/API Standard 670 mentioned above, and would be suitable for use with the present invention.

The transducer output is connected to conditioning and A/D conversion circuitry 32. This circuitry can be configured to perform a variety of functions. In many applications, the analog acceleration signal is filtered to produce a varying DC voltage or current signal which is representative of the peak or RMS acceleration, velocity, or relative position of the transducer 53. As is well known to those of skill in the art, a variety of filtering techniques may be used to extract information regarding the performance and condition of the bearings in the stationary machinery 10. The filtered and conditioned signal is then sampled with an A/D converter to produce a series of digitized signal values. Of course, A/D conversion can occur at a rate which varies depending on the frequencies of interest in the signal being sampled. In some applications, the transducer output may be only amplified prior to A/D conversion and not conditioned or filtered. In this embodiment, conditioning and processing can be done at the central server 17 or analyst computer 22. This can allow additional analysis flexibility, as the central server 17 or analyst computer 22 receives raw transducer data, and can process that data in various ways depending on the parameters of interest, recent history of the bearing being monitored, etc.

In yet another alternative embodiment, the nature of processing performed by the conditioning and A/D conversion circuitry 32 can be programmed with signals sent from the central server 17 to the remote site 10. In this embodiment, the conditioning circuit 32 may additionally comprise a memory, wherein commands stored in the memory control the particular conditioning function and filtering performed at a given time. Commands may be sent from the central server 17 for storage in the memory, thereby allowing remote control of the conditioning function, filter parameters, etc.

The digital data is stored in a memory 42. The memory 42 may in part comprise a non-volatile memory and be utilized to store data temporarily prior to transmission over the wireless link 16. As described above, the circuitry of FIG. 3 may be split between a pen 14 and a hand-held processing device 15. In many instances, the connector/transducer 53, conditioning and conversion circuitry 32, some of the processing circuitry 51 and some of the memory 42 are provided in the pen 14. However, any or all of these components can be in a single housing, or split between multiple housings, in any convenient manner.

The conditioned data is routed to a transceiver. The transceiver includes both transmitter circuitry 44 and receiver circuitry 46 for two way communication via the wireless link 16. The GUI 50 can display collected data, measurement instructions received from the central server 17, data stored in the memory 42, or features and attributes of the machine 10. Features may include schematics, drawings, dimensions, or the like. Advantageous two-way page communication may be implemented with the systems illustrated in FIGS. 1 and 2. The HHD 14/15 further comprises processing circuitry 51 and software 48, which is described in additional detail below.

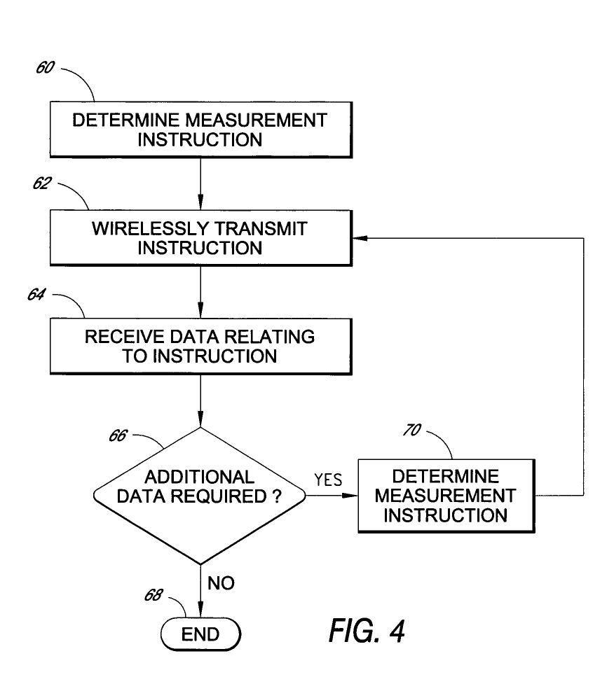

FIG. 4 is a flowchart illustrating a method of data communication which may be implemented by a server in the systems illustrated in FIGS. 1 and 2. The communication method is initiated at block 60 with the server determining one or more measurement instructions for one or more machines 10. In some embodiments, an HHD 15 initiates the method by sending information identifying the machine 10 to the central server 17. This information may include a model number, location or a machine identification code (e.g. bar code, RFID tag, etc.). For example, the HHD may send a request for a route to the central server 17.

Next at block 62, the server wirelessly transmits the measurement instruction to the HHD 15. The wireless network can use a cellular, PCS, CDMA, GSM, FDMA, TDMA, WiFi, or other communication protocol. At block 64, the server receives data from the HHD in response to the measurement instruction transmitted at block 62. The HHD collects, processes, and/or stores the data in the memory 42. The HHD may include circuits required for signal acquisition and conditioning and/or transmission circuitry.

At decision block 66, the server analyzes the received data to determine if additional data is required from the machine 10. This analysis may include a comparison to a threshold value, previous values for the applicable model or type of device, and/or concurrent measurements from another machine. If the received data was the last measurement instruction for the route, the process moves to a block 68 where the process ends. If during the route, the value of the measured data, for example, is greater than a threshold or an alarm condition exists, the server may require additional data and add or change measurement instructions as the route is performed.

Returning to decision block 66, if the server determines that additional measurements are required, the process moves to block 70 where the server determines the next measurement instruction or command. The process then moves to block 62 where the measurement instruction(s) are wirelessly transmitted to the HHD. The process then continues as described above until the server determines that no additional data is required. The communication is then completed as represented by end block 68.

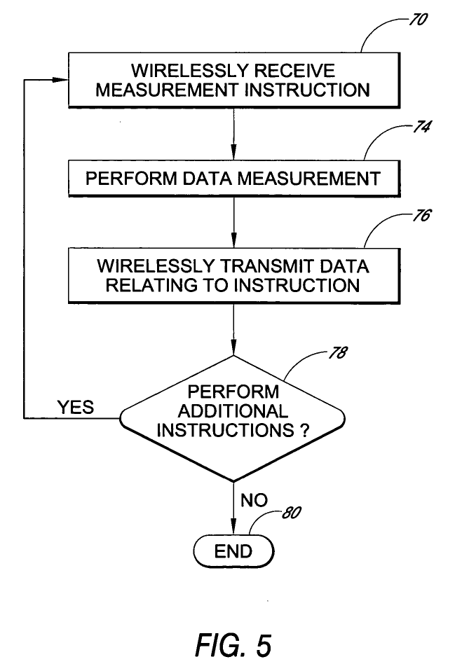

FIG. 5 is a flowchart illustrating a method of data communication which may be implemented by the portable handheld device (“HHD”) in the systems illustrated in FIGS. 1 and 2. The communication method is initiated at block 70 with the HHD 15 receiving one or more measurement instructions from a server. In some embodiments, the HHD initiates the method by sending information identifying the machine 10 to the central server 17. This information may include, for example, a model number, location, or identifier as described above.

At block 74, the operator utilizes the HDD 15 to collect data that corresponds to the measurement instruction received from the server. The collected data uploaded to the server. The process then moves to block 76 where the collected data is wirelessly transmitted to the server.

At decision block 78, the HHD awaits a measurement instruction from the server. When received, the operator of the HHD 15 performs the additional instruction. If no additional instruction is received and the route is completed, the process moves to end block 80. If an additional instruction is received, the process returns to block 70 where the HHD receives that instruction. The process then continues as described above until the server determines that no additional data is required. The communication is then completed as represented by end block 80.

In order to accommodate an environment whereby wireless network access might be “spotty”, a caching mechanism that caches future instructions (e.g. batches of instructions defining a route section or portion of a route) as well as acquired data may be provided. This mechanism may automatically synchronize the HHD and server data sets when the wireless network reconnects. In this way, instructions may continue to be available to the user of the HHD even if no new instructions are being sent to the user continuously as data is being collected.

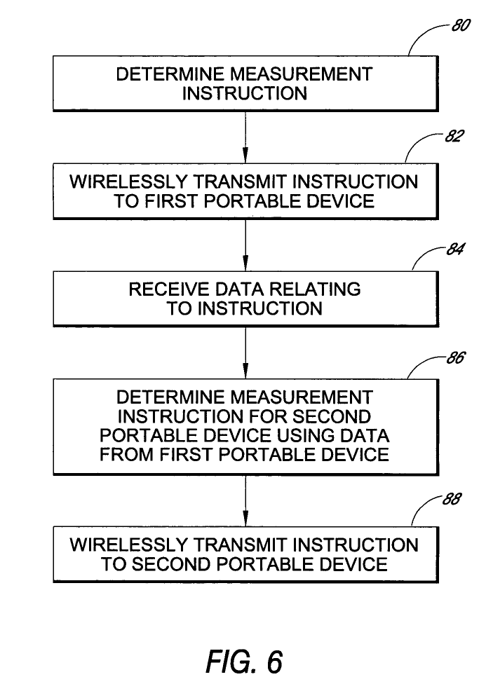

FIG. 6 is a flowchart illustrating a method of data communication which may be implemented by a server in the system illustrated in FIG. 2. The communication method is initiated at block 80 with the server determining one or more measurement instructions for one or more machines 10. In some embodiments, one or both of the HHD 15(a), 15(b) initiate the method by sending information identifying one or both machines 10(a), 10(b) to the server.

Next at block 82, the server wirelessly transmits the instruction to the HHD 15(a) via a wireless link. The HHD 15(a) displays the instruction for the operator. At block 84, the server receives measurement data from the HHD 15(a) in response to the instruction transmitted at block 82.

Next at block 86, the server determines one or more measurement instructions for the machine 10(b). Advantageously, the server can utilize the data received from HHD 15(a) when determining the measurement instructions for HHD 15(b). The server can, for example, analyze the data received from HHD 15(a) to determine if additional data is required from the machine 10(b). The data received from HHD 15(a) may be useful for determining measurement instructions for machine 10(b) when, for example, machine 10(a) and machine 10(b) have common characteristics. These characteristics may include, model, type, environment, location, or the like. At block 88, the server transmits the measurement instruction to HHD 15(b) for the operator, wherein the content of the instruction may depend upon the data previously gathered by the other HHD 15(a).

It is one benefit of the above described data gathering/analysis systems and methods that they can be implemented with industry standard software and communication protocols. The system may utilize existing internet browser techniques or proprietary browsing techniques to implement all HHD functionality in a web based application through Active Server Pages, Java, Javascript, SOAP or any other applicable browser programming language or proprietary network commands. Thus, the HHD can run a simple internet Web browser such as Netscape Navigator or Internet Explorer which requests and receives the instructions (route) as sent to it from the central server by means of standard internet protocols (e.g. HTTP) in the form of interactive HTML web pages.

As described above, the server may be configured to process the data immediately so that the actual progression of the route (which data is taken and how) is changed on the fly in order to accommodate “ad hoc” data taking to better address unforeseen situations. This can be done, for example, with Active Server Pages that include server-side scripts. When a piece of data is received from an HHD, the script in the requested page can process previously received data (from the same or different HHDs as described above) and alter the content of the subsequently sent HTML page based on the data so as to change the route on the fly.

The server may also send alert messages to other processes including ERP software (Enterprise Resource Planning) and/or a diagnostics team. On-demand route instructions can become very detailed including machinery diagrams and details as to how to place a measurement probe or what to do during data taking.

Software mechanisms can also be provided whereby the browser on the HHD is enabled to connect to an external device such as a temperature sensor or vibration collection device (e.g. the pen 14 described above when it is coupled to the HHD with a cable) to facilitate direct data intake so that the user does not need to manually log the device's data. This interface may be accomplished by a standard, browser accepted DLL or ActiveX component, which may have been transparently downloaded from the server on demand.

As the HHD is connected to the server during performance of the route, it is not necessary to download the route all at once at the beginning nor is it necessary to upload the resulting data set all at once at the end. This saves a significant amount of time in particular for large routes. Areas where network access is less than sufficient may cause a caching mechanism to become operative, which may transparent to the user. Therefore, even in these situations no time is lost.

As data is updated in the server almost instantaneously, the server software can process this and take action immediately. The server process may determine that additional or other data is required and automatically alters the “route” so that the user in the field is supplied with the proper instructions. This in essence makes any “route” dynamic rather than a static list, which reacts to issues in the field by acquiring more signal data, signal data of a different type (i.e., a different measurement) and/or a portion of the normally scheduled route is skipped all together.

In addition, memory required for route storage in the HHD may be drastically lower. Routes are mainly stored on the server and relatively small pieces are constantly sent to the HHD on “as needed” bases. The unoccupied memory becomes available for other usage. Upgrading the HHD firmware may come down to installing a single new set of server software, which can be configured to instantly “upgrade” each HHD. Not only is the upgrade process simple and quick, only a single location needs to be updated (HHD units in the field need not be returned) in addition, the update may be carried out by IT personnel as the software is essentially a web server whereas in the previous situation the maintenance manager was tasked with this action. Field based users may request server-based documentation. This “on the spot” documentation may be specific to the issue the user is dealing with such as detailed drawings, procedures, troubleshooting guides etc.

The foregoing description details certain preferred embodiments of the present invention and describes the best mode contemplated. It will be appreciated, however, that no matter how detailed the foregoing appears in text, the invention can be practiced in many ways. As is also stated above, it should be noted that the use of particular terminology when describing certain features or aspects of the present invention should not be taken to imply that the broadest reasonable meaning of such terminology is not intended, or that the terminology is being re-defined herein to be restricted to including any specific characteristics of the features or aspects of the invention with which that terminology is associated. The scope of the present invention should therefore be construed in accordance with the appended Claims and any equivalents thereof.

What is claimed is:

1. A wireless monitoring system for measuring and processing operational characteristics of one or more machines, the system comprising:
a central computer configured to determine a first series of measurement instructions for the one or more machines; and
a portable computer configured to receive each instruction from the first series of measurement instructions over a wireless link and to serially transmit measurement data over the wireless link, wherein at least a portion of the instructions for the first series of measurement instructions is transmitted after a portion of the first series of measurement instructions have been completed.

2. The system as in claim 1, wherein the central computer is configured to determine a revised series of measurement instructions for the one or more machines using at least a portion of the received measurement data.

3. The system as in claim 1, wherein the portable computer further comprises a memory configured to store measurement data for subsequent transmission when the wireless link is severed, and wherein the portable computer is further configured to transmit said measurement data after the wireless link is restored.

4. The system as in claim 1, wherein the portable computer serially receives each instruction from the first series of measurement instructions and transmits said measurement data in response to each received instruction.

5. The system as in claim 1, wherein at least some measurement data is transmitted before the portable computer receives the entire first series of measurement instructions.

6. The system as in claim 1, wherein the portable computer comprises a processor and software, and wherein the processor executes instructions defined by the software.

7. The system as in claim 1, wherein the first series of measurement instructions includes a temperature measurement.

8. The system as in claim 1, wherein the first series of measurement instructions includes a vibration measurement.

9. The system as in claim 1, wherein the first series of measurement instructions comprises an ordered set of a plurality of measurements.

10. The system as in claim 9, wherein the central computer is configured to determine a second order for taking the first series of measurements after the first order is received by the portable computer.

11. A wireless monitoring system comprising:
a central computer configured to determine a first series of measurement instructions and to select a first measurement instruction from the first series of measurement instructions;
a transmitter configured to transmit the first measurement instruction over a wireless link; and
a portable computer configured to receive the first measurement instruction and to transmit measurement data taken in response to the first measurement instruction over the wireless link.

12. A method of monitoring the condition of a machine, the method comprising:
selecting a first measurement instruction at a central computer;
wirelessly receiving the first measurement instruction;
connecting a transducer to the machine for collecting data, wherein the data relates to the first measurement instruction;
transmitting the data to the central computer;
processing the transmitted data at the central computer;
selecting a second measurement instruction at the central computer; and
wirelessly receiving the second measurement instruction from the central computer.

13. The method of claim 12, wherein the first measurement instruction and the second measurement instruction are received over the same wireless link.

14. The method of claim 12, wherein determining the second measurement instruction comprises comparing a previous measurement for the machine to the processed data.

15. The method of claim 12, wherein determining the second measurement comprises comparing a predetermined threshold value to the processed data.

16. The method of claim 12, wherein the first measurement instruction includes a type of and location for collecting data from the machine.

17. A portable computer for an operator to receive and display instructions for measuring operational characteristics of a machine, the portable computer comprising:
means for wirelessly receiving an instruction from a central computer to measure an operational characteristic of the machine;
software configured to interpret the received instruction;
a processor configured to execute the software;
a graphical user interface configured to display information related to the instruction and to the operational characteristic of the machine;
a connector configured to receive data related to the operational characteristic; and
means for transmitting the data to the central computer.

18. The portable computer of claim 17, wherein the means for wirelessly receiving the instruction from the central computer is further configured to receive a second instruction from the computer, wherein the second instruction is based at least in part on the data transmitted by the means for transmitting.

19. The portable computer of claim 18, wherein the display information identifies a location on the machine for locating the measurement device.

20. The portable computer of claim 18, wherein the display information identifies a type of measurement.

21. The portable computer of claim 20, wherein the type of measurement is a temperature measurement.

22. The portable computer of claim 20, wherein the type of measurement is a vibration measurement.

23. A central computer for determining a plurality of instructions for an operator to perform a plurality of measurements to determine the operational characteristics of a type of machine, the central computer comprising:
software configured to determine a series of instructions for the operator to perform the plurality of measurements;
a processor configured to execute the software;
a transmitter configured to transmit a first instruction and a second instruction from the series of instructions to a portable computer over a wireless link;
a receiver configured to receive data related to the transmitted first instruction from the portable computer over the wireless link; and
means for selecting the second instruction of the series of instructions based at least in part on the data related to the first instruction.

24. The central computer of claim 23, further comprising a graphical user interface configured to display data related to the transmitted first instruction.

25. The central computer of claim 23, wherein the means for determining the second instruction comprises software.

26. The central computer of claim 23, wherein the means for determining the second instruction comprises displaying the data to an analyst.

27. A method of monitoring the condition of a machine, the method comprising:
forming a wireless link between a central computer and a portable computer;
wirelessly receiving a first measurement instruction from the central computer over the link;
connecting a transducer to the machine for collecting data relating to the first measurement instruction;
transmitting the data to the central computer over the link; and
wirelessly receiving a second measurement instruction from the central computer over the link.

28. The method of claim 27, wherein the wireless link between the central computer and the portable computer is maintained at least from a time when the first measurement instruction is received to a time when the second measurement instruction is received.

29. The method of claim 27, wherein the method utilizes a packet protocol for the link.

30. The method of claim 27, wherein the second measurement instruction is in the form of an Active Server Page.

31. The method of claim 30, wherein the Active Server Page is based at least in part on the data related to the first instruction.

32. The method of claim 30, wherein at least a portion of the Active Server Page is in HyperText Markup Language (HTML) format.

33. A method of performing a machine monitoring data collection route comprising receiving data collection instructions from a central computer substantially continuously while performing the data collection route.

34. The method of claim 33, further comprising sending collected data to the central computer substantially continuously while performing the data collection route.

35. The method of claim 33, wherein at least a portion of the data collection instructions are predetermined.

36. The method of claim 34, wherein at least a portion of the data collection instructions are selected using at least a portion of the collected data sent to the central computer.

37. The method of claim 34, further comprising contacting a measurement device to the machine to obtain at least a portion of the collected data.

38. The method of claim 37, wherein the collected data includes a temperature measurement.

39. The method of claim 37, wherein the collected data includes a vibration measurement.

40. The method of claim 33, further comprising displaying instructions related to the data collection route.

41. The method of claim 40, wherein the instructions identify a location on the machine for performing at least a portion of the data collection route.

42. A method of simultaneously monitoring the condition of a plurality of machines at a central server, the method comprising:
forming a first wireless link between a central computer and a first portable device;
wirelessly receiving a first measurement instruction from the central computer at the first portable device over the first wireless link;
forming a second wireless link between the central computer and a second portable device, the second portable device being remotely located from the first portable device;
wirelessly receiving a second measurement instruction from the central computer at the second portable device over the second wireless link;
transmitting collected data to the central computer over the second wireless link; and
wirelessly receiving a third measurement instruction at the first portable device over the first wireless link, wherein the third measurement instruction is determined using the data collected from the second portable device.

43. The method of claim 42, wherein the first portable device receives the third instruction after the second portable device receives the second instruction.
